(19) United States
(12) Patent Application Publication
(10) Pub. No.: US 2026/0317624 A1
(43) Pub. Date: Oct. 15, 2026

(54) PROCESS TO STABILIZE SOIL

(71) Applicants: DOW GLOBAL TECHNOLOGIES LLC, Midland, MI (US); ROHM AND HAAS COMPANY, Collegeville, PA (US)

(72) Inventors: Milena M. Avancini, Jundial (BR); Mark D. Westmeyer, Collegeville, PA (US); Kimy Yeung, Phoenixvllle, PA (US); Eduardo Oliveira Cruz, Walsrode (DE); Luz Adriana Gomez Ortiz, Bremen (DE); Jessica R. Levin, Collegeville, PA (US)

(21) Appl. No.: 19/485,447

(22) PCT Filed: Jun. 5, 2024
(86) PCT No.: PCT/US2024/032523

§ 371 Date: Nov. 18, 2025

(30) Foreign Application Priority Data
Jun. 12, 2023 (US) 63507559

(51) Int. Cl. C09K 17/22; E02D 3/12

(52) U.S. Cl. CPC C09K 17/22; E02D 3/123

(57) ABSTRACT

Soil containing high levels of clay can be stabilized by applying an aqueous stabilizer solution that contains a dissolved polyacrylic acid polymer that (a) has a weight average molecular weight (Mw) from 10,000 Da to 500,000 Da; and (b) contains at least 60 weight percent repeating units derived from acrylic acid, in the absence of an organic amine.

### FIELD

This invention relates to the art of stabilizing soil.

### INTRODUCTION

Soil normally comprises a mix of sand, silt, clay and organic material. Different soil types provide different levels of support for roads and structures. Soils that contain high levels of sand often provide good support. On the other hand, soils that contain high levels of silt or clay may provide less support. In particular, soils that contain high levels of clay may turn plastic or even liquid when saturated with water and provide poor support.

Soil that must support roads or other paved surfaces is often classified and tested for bearing capacity and then stabilized as needed before the base and paved surface is added.

Different countries use different systems to classify soil. In the USA, three systems are in common use. The system of the American Association of State Highway and Transportation Officials (AASHTO) is frequently used in construction projects. The Unified (USCS) classification system and the USDA classification system are also used. These three US classification systems are summarized in publications, such as Geotechnical Manual, Chapter 3, Section 3 “Soil Classification Systems” (2017) published by Wisconsin (USA) Department of Transportation. Other countries may also use these systems or may use their own systems for classification.

A standard test to measure the bearing capacity of soil is the California Bearing Ratio test (ASTM D1883), which measures the penetration of a piston into a soil sample. The results are reported as a percent of the bearing ability of an idealized sample, so that higher percentage is better.

Many techniques to stabilize soil are known, from simple compaction to addition of stabilizing compounds such as cement, lime, fly ash or polymeric or enzyme-based stabilizers. See, for example, Firoozi et al., Fundamentals of Soil Stabilization, 8 Geo-Engineering 26 (2017) (https://doi.org/10.1186/s40703-07-0064-9) and Khan et al., Different Soil Stabilization Techniques, 29(9) Int'l J. Adv. Sci. & Tech. 7778-7791 (2020). Soils in AASHTO categories A-1, A-2 and A-3 may need only compaction. On the other hand, soils in AASHTO categories A-4 to A-7 frequently need chemical stabilization in addition to compaction. It is common to stabilize high-clay soils by adding in cement, but cement is an expensive stabilizer. Depending on the soil and its intended use, the added cement may make up 1 to 10 weight percent of the soil.

It would be useful to identify alternative stabilizers that can be used in high-clay soils in place of cement.

### SUMMARY

One aspect of the present invention is a process to stabilize a layer of soil that contains high levels of clay, called “high-clay soil”, comprising the steps of
(a) mixing together a loose layer of the high-clay soil with an aqueous stabilizer solution that contains (1) less than 0.05 parts organic amine per 100 parts high-clay soil; and (2) a dissolved polyacrylic acid polymer that:
   (i) has a weight average molecular weight (Mw) from 10,000 Da to 500,000 Da; and
   (ii) contains at least 60 weight percent repeating units derived from acrylic acid; and
(b) compacting the loose high-clay soil layer.

A second aspect of the present invention is a compacted soil layer comprising:
(a) at least 95 weight percent soil that contains high levels of clay, called “high-clay soil”; and
(b) a water-soluble polyacrylic acid polymer in a concentration suitable to stabilize the high-clay soil, which water-soluble polyacrylic acid:
   (i) has a weight average molecular weight (Mw) from 10,000 Da to 500,000 Da; and
   (ii) contains at least 60 weight percent repeating units derived from acrylic acid; and
(c) from 0 to less than 0.05 parts organic amine per 100 parts high-clay soil.

We have discovered that the polyacrylic acid polymers described above can significantly increase the stability of high-clay soils. We hypothesize, without intending to be bound, that interactions between acid groups on the polyacrylic acid polymer and anionic components in the high-clay soil may contribute to stabilizing the high-clay soil. Further, the polymer may form a coating adhered to the clay particles that protects the clay particles from water.

### DETAILED DESCRIPTION

The present invention stabilizes a soil that contains high levels of clay, called a “high-clay soil”. In some embodiments, the high-clay soil contains at least 35 weight percent clay or at least 40 weight percent clay or at least 50 weight percent clay or at least 60 weight percent clay. In some embodiments, the high-clay soil contains no more than 65 weight percent sand or no more than 60 weight percent sand or no more than 50 weight percent sand or no more than 40 weight percent sand or no more than 30 weight percent sand.

In some embodiments, the high-clay soil meets AASHTO classification A-6 or A-7. In some embodiments, the high-clay soil meets AASHTO Classification A-6. In some embodiments, the high-clay soil meets AASHTO Classification A-7.

In some embodiments, the high-clay soil meets USCS Classification SC, CL, CH or OH. In some embodiments, the high-clay soil meets USCS Classification CH or OH.

In some embodiments, the high-clay soil meets the USDA Classification for Clay, Sandy-Clay, Clay Loam, Silty-Clay Loam or Silty Clay. In some embodiments, the high-clay soil meets the USDA Classification for Clay. In some embodiments, the high-clay soil meets the USDA Classification for Silty-Clay Loam or Silty Clay.

In some embodiments, at least 36 weight percent of the high-clay soil particles pass through a 200 mesh screen, or at least 40 weight percent or at least 45 weight percent or at least 50 weight percent or at least 55 weight percent. In some embodiments, no more than 90 weight percent of the high-clay soil particles pass through a 200 mesh screen or no more than 80 weight percent or no more than 70 weight percent.

In some embodiments, the liquid limit of the high-clay soil is at least 20 percent or at least 30 percent or at least 40 percent or at least 50 percent. In some embodiments, the liquid limit of the high-clay soil is at most 80 percent or at most 70 percent or at most 60 precent. In some embodiments, the liquid limit of the high-clay soil is 40 percent to 60 percent.

In some embodiments, the plasticity index of the high-clay soil is at least 11 percent, or at least 15 percent or at least 20 percent or at least 25 percent. In some embodiments, the plasticity index of the high-clay soil is at most 50 percent or at most 40 percent or at most 30 percent.

The stability of high-clay soil can be rated according to California Bearing Ratio (CBR) test, as measured by ASTM D1883. In some embodiments, the unstabilized high-clay soil has a CBR of no more than 30 percent or no more than 25 percent or no more than 20 percent. In some embodiments, the unstabilized high-clay soil has a CBR of at least 10 percent or at least 12 percent or at least 14 percent or at least 16 percent.

The high-clay soil is mixed in a loosened soil layer with an aqueous stabilizer solution that contains a dissolved polyacrylic acid (PAA) polymer. Polyacrylic acid polymers contain repeating units derived from acrylic acid, as shown in Formula 1:

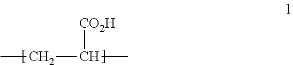

In PAA polymers used in this invention, at least 60 weight percent of the repeating units are derived from acrylic acid.

In some embodiments, the PAA polymer is a homopolymer, in which essentially all repeating units are derived from acrylic acid.

In some embodiments, the PAA polymer is a copolymer in which at least 60 weight percent of repeating units are derived from acrylic acid and up to 40 weight percent of repeating units are derived from a comonomer. In some embodiments, at least 65 weight percent of repeating units in the PAA polymer are derived from acrylic acid, or at least 70 weight percent or at least 75 weight percent or at least 80 weight percent or at least 85 weight percent or at least 88 weight percent or at least 90 weight percent. In some embodiments, up to 100 weight percent of repeating units in the PAA polymer are derived from acrylic acid, or at most 99 weight percent or at most 95 weight percent or at most 92 weight percent or at most 90 weight percent. In some embodiments, at least 1 weight percent of repeating units in the PAA polymer are derived from comonomers, or at least 5 weight percent or at least 8 weight percent or at least 10 weight percent. In some embodiments, up to 35 weight percent of repeating units in the PAA polymer are derived from comonomers, or up to 30 weight percent or up to 25 weight percent or up to 20 weight percent or up to 15 weight percent or up to 12 weight percent or up to 10 weight percent.

Suitable comonomers include unsaturated monomers capable of free-radical polymerization. Examples of suitable comonomers include methacrylic acid, methyl acrylate, ethyl acrylate, butyl acrylate, methyl methacrylate, ethylene, propylene and styrene. In some embodiments, the comonomer is ethyl acrylate. In some embodiments, the PAA polymer contains repeating units derived from 88 to 100 weight percent acrylic acid and 0 to 12 weight percent ethyl acrylate. In some embodiments, the comonomer and its concentration in the polymer are selected such that the PAA polymer can dissolve in the aqueous stabilizer solution while maintaining useful viscosity under conditions that it is used, which may entail high concentrations of PAA polymer in a low pH solution as described below.

The PAA polymer has a weight average molecular weight of 10,000 Da to 500,000 Da. In some embodiments, the PAA polymer has a weight average molecular weight of at least 15,000 Da or at least 20,000 Da or at least 30,000 Da or at least 40,000 Da or at least 50,000 Da or at least 60,000 Da or at least 70,000 Da or at least 80,000 Da or at least 90,000 Da. In some embodiments, the PAA polymer has a weight average molecular weight of at most 400,000 Da or at most 300,000 Da or at most 260,000 Da or at most 200.000 Da or at most 150,000 Da.

In some embodiments, at least 50 percent of acid groups in the PAA polymer remain in an acidic state (i.e. the hydrogen has not been neutralized with a base or otherwise replaced with another substituent), or at least 60 percent or at least 70 percent or at least 80 percent or at least 90 percent. In some embodiments, essentially all of acid groups in the PAA polymer (up to 100 percent) remain in an acidic state.

The PAA polymer is dissolved in water to form an aqueous stabilizer solution. In some embodiments, the aqueous stabilizer solution contains at least 5 weight percent PAA polymer or at least 10 weight percent PAA polymer or at least 15 weight percent PAA polymer or at least 20 weight percent PAA polymer or at least 22 weight percent PAA polymer or at least 24 weight percent PAA polymer. There is no maximum desired concentration of PAA polymer, but aqueous stabilizer solutions that contain more than 40 weight percent PAA polymer or 30 weight percent PAA polymer may be difficult to make with useful viscosity.

The PAA polymer is acidic, and as a result the aqueous stabilizer solution containing high loadings of PAA polymer may have a low pH. In some embodiments, the aqueous stabilizer solution has a pH of no more than 4 or no more than 3 or no more than 2.5 or no more than 2.3 or no more than 2.1. In some embodiments, the aqueous stabilizer solution has a pH of at least 1.5 or at least 1.7 or at least 1.9 or at least 2.

Some PAA polymers can increase the viscosity of an aqueous stabilizer solution, especially with high polymer content and/or low pH. In some embodiments, the aqueous stabilizer solution containing stabilizer has a viscosity of no more than 2000 cP or no more than 1000 cP or no more than 800 cP or no more than 600 cP or no more than 400 cP or no more than 300 cP. In some embodiments, the viscosity of the aqueous stabilizer solution is at least 10 cP or 50 cP or 90 cP.

Suitable PAA polymers and their aqueous solutions are commercially available. Other PAA polymers can be made by free-radical polymerization of acrylic acid, optionally with comonomers, according to known processes. See for example, U.S. Pat. No. 2,289,540 and Zahran et al., Poly Acrylic Acid: Synthesis, Aqueous Properties and their Applications as scale Inhibitor, published by KGK Rubberpoint at https://www.kgk-rubberpoint.de/wp-content/uploads/2016/08/KGK_7-8_2016_53-58.pdf.

The aqueous stabilizer solution can be mixed with the layer of loose soil using known methods. Methods to mix soil with stabilizers are known, and equipment is commercially available. In some embodiments, the mixing is performed in place; and in some embodiments, the mixing is performed remotely, and the mixture is deposited where needed.

For mixing-in-place, equipment can simultaneously loosen the soil and apply the aqueous stabilizer solution. Alternatively for mixing-in-place, the soil can be loosed by scarifying (breaking up and turning up) the existing surface using known equipment such as scarifiers, pulverizers and graders with scarifying blades. Then the aqueous stabilizer solution can be added to the loose soil layer by known means, such as spraying or pouring. If necessary, the aqueous stabilizer solution can be further mixed into the loose soil layer using known soil-mixing equipment.

The quantity of aqueous stabilizer solution mixed into the high-clay soil should be high enough to stabilize the layer of loose high-clay soil after compaction. In some embodiments, the weight ratio of PAA polymer to loose high-clay soil is at least 0.1 weight percent or at least 0.3 weight percent or at least 0.5 weight percent or at least 0.7 weight percent or at least 0.9 weight percent. In some embodiments, the weight ratio of PAA polymer to loose high-clay soil is at most 8 weight percent or 5 weight percent or 4 weight percent or 3 weight percent or 2 weight percent or 1.5 weight percent or 1.2 weight percent.

In contrast to some stabilizing additives, organic amines are not a critical part of the stabilizing additives in this invention and are not added to the high-clay soil. The aqueous stabilizer solution contains less than 0.05 parts organic amine per 100 parts high-clay soil. In some embodiments, the aqueous stabilizer solution contains no more than 0.045 parts organic amine per 100 parts high-clay soil, or no more than 0.040 parts organic amine per 100 parts high-clay soil, or no more than 0.03 parts organic amine per 100 parts high-clay soil, or no more than 0.02 parts organic amine per 100 parts high-clay soil, or no more than 0.01 parts organic amine per 100 parts high-clay soil. In some embodiments, the aqueous stabilizer solution contains essentially no organic amine (0 parts organic amine per 100 parts high-clay soil).

In some embodiments, other stabilizing additives may also be added to the high-clay soil to further stabilize it, if the other additives do not interfere with the PAA polymer. Examples of other stabilizing additives are discussed in the background.

In some embodiments, large quantities of cement stabilizers are not added to the high-clay soil. For example, in some embodiments, the quantity of cement added to the high-clay soil is from 0 weight percent to no more than 2 weight percent or no more than 1 weight percent or no more than 0.9 weight percent or no more than 0.8 weight percent or no more than 0.7 weight percent or no more than 0.5 weight percent or no more than 0.3 weight percent or no more than 0.1 weight percent.

Regardless of how it is performed, the mixing step creates a loosened soil layer mixed with an aqueous stabilizer solution. In some embodiments, the layer of loose high-clay soil is at least 5 cm deep or at least 10 cm or at least 12 cm or at least 15 cm or at least 18 cm or at least 20 cm. In some embodiments, the layer of loose high-clay soil is at most 100 cm deep or at most 80 cm or at most 60 cm or at most 50 cm or at most 40 cm or at most 30 cm or at most 25 cm or at most 20 cm.

In some embodiments, the loose soil layer is spread, graded and/or leveled to create the desired shape and grade after the aqueous stabilizer solution is mixed in and before the soil is compacted. This can be accomplished with known plows, dozers and graders.

After the layer of loose high-clay soil is mixed with the aqueous stabilizer solution and is graded (if any grading is done), the soil is compacted. Compaction can be accomplished by known means, such as with rollers, rammers or vibratory compactors. In some embodiments, the compaction is accomplished using a roller. The desired level of compaction may vary depending on the intended use of the site. In some applications, a compaction of at least 80 to 85 percent of maximum dry density is desirable. In some applications, a compaction of at least 90 or 95 percent maximum dry density is desirable.

The process creates a stabilized layer of high-clay soil that contains the PAA polymer and optionally other additives in the quantities previously described. The description and concentration of PAA polymer are as previously described. The stabilized layer of high-clay soil contains less than 0.05 parts organic amine per 100 parts high-clay soil, as previously described.

In some embodiments, the stabilized layer of high-clay soil has a CBR of at least 20 percent or at least 25 percent or at least 30 percent or at least 35 percent or at least 40 percent or at least 45 percent.

In some embodiments, the CBR of soil stabilized using this invention is at least 1.5 times the CBR of the unstabilized soil, or at least 2.0 times the CBR of the unstabilized soil or at least 2.5 times the CBR of the unstabilized soil or at least 3 times the CBR of the unstabilized soil, when measured according to the Test Methods. There is no maximum desirable improvement in CBR, but it may be unnecessary to seek CBR improvement more than 5 times the CBR of the unstabilized soil.

### Test Methods

Unless stated otherwise, measurements listed in this application are made using the following test methods:

| Parameter | Test |
|---|---|
| Aggregate Particle Size | ASTM C0136: Sieve analysis |
| Profile | |
| Liquid Limit, Plastic Limit | ASTM D4318 |
| and Plasticity Index | |
| California Bearing Ratio | ASTM D1883 |
| (CBR) | |
| Polymer Molecular Weight | See below |
| Solution Viscosity | ASTM D5225-17 |
| Solution pH | ASTM E70 |

Polymer Molecular Weight: Molecular weight (Mw) is measured using gel permeation chromatography (GPC), also known as size exclusion chromatography (SEC). This technique utilizes an instrument containing columns packed with porous beads, an elution solvent, and detector in order to separate polymer molecules of different sizes. Measurement of molecular weight by SEC is well known in the art and is discussed in more detail in, for example, Slade, P. E. Ed., Polymer Molecular Weights Part II, Marcel Dekker, Inc., NY, (1975) 287-368; Rodriguez, F., Principles of Polymer Systems 3rd ed., Hemisphere Pub. Corp., NY, (1989) 155-160; U.S. Pat. No. 4,540,753; and Verstrate et al., Macromolecules, vol. 21, (1988) 3360; T. Sun et al., Macromolecules, Vol. 34, (2001) 6812-6820; and U.S. Pat. No. 9,670,345B2 (col 20-21).

### EXAMPLES

The following examples illustrate specific embodiments of the invention, but do not limit the broadest scope of the invention.

The materials in Table 1 are used for the Examples:

TABLE 1

| Material | Generic description | Source | Further description |
|---|---|---|---|
| Soil | AASHTO A-7 Soil | Jundiai, Sao | Liquid limit 58%, plastic limit |
| | | Paulo, Brazil | 36%, plastic index 22%. |
| Cement | Portland Cement | Holcim | Fast curing ASTM C 150 type |
| | CPV ARI Ultra Rapido | | (III) Ordinary Portland cement |
| ACRYSOL ™ | alkali-soluble emulsion | TDCC* | 28 percent solids solution of |
| ASE-60 copolymer | (ASE) thickener | | methacrylic acid/ethyl acrylate |
| | | | copolymer |
| Commercial PAA | acrylic acid | TDCC* | 100% acrylic acid homopolymer |
| Polymer 1 | homopolymer | | with a weight average molecular |
| | | | weight from 60,000 Da to |
| | | | 80,000 Da. |
| TAMOL ™ 731A | hydrophobic copolymer | TDCC* | 25% solid solution of |
| dispersant | dispersant | | hydrophobic copolymer |
| | | | polyelectrolyte in water |
| EarthZyme | Soil stabilizer | Cypher | Commercial Enzyme soil |
| | | Environmental | stabilizer |

*TDCC = The Dow Chemical Company

### Preparation of Acidic Polymers:

A 5-liter 4 neck round bottom glass reactor is equipped with C-shaped stirring shaft, condenser, thermocouple, adapter for nitrogen, and feed ports for monomer and catalyst feeds. The reactor is charged with 1768 g of deionized water (DI) and blanketed with nitrogen. The reactor is heated to 90° C. and maintained at 90° C.+/−2° C. during the reaction. An initial catalyst feed consisting of 5.7 g of ammonium persulfate (APS) dissolved in 46 g of DI is added to the reactor. A 986 g quantity of monomer shown in Table 1 is fed to the reactor at a rate of 657 grams per hour. Concurrent with the monomer feed, a catalyst cofeed consisting of 8.2 g of APS dissolved in 277 g of DI is fed to the reactor at a rate of 190 grams per hour. A dilution feed of 196 g of DI is also fed to the reactor during the monomer feeds. The dilution water is fed at 130 grams per hour. Once all feeds are complete, the reaction temperature is maintained at 90° C.+/−2° C. for 15 min before cooling to room temperature and a final charge of 407 g of DI is added to the reactor. The product is an aqueous polyacrylic acid solution that contains 25.4 percent solids, has a pH of 2.1, has a viscosity of 128 cps (Brookfield #2 at 30 rpm), and has a polymer weight average molecular weight (M_{w}) of 99732 Da. The solution is labelled Inventive Stabilizer 1 (IS1).

The reaction is repeated using varying levels of APS as shown in Table 1 to make different aqueous acrylic acid polymer solutions shown in Table 2. IS 1 to IS 6 are inventive stabilizers within the scope of the invention. CS 1 to CS 3 are comparative stabilizers outside the scope of the invention.

TABLE 2

| | | % | | % |
|---|---|---|---|---|
| Stabilizer ID | Monomer* | APS | M_{w} | Solids |
| IS 1a | 100% AA | 1.4 | 99732 | 25.4 |
| IS 1b | 100% AA | 1.4 | 114572 | 26.0 |
| IS 2 | 100% AA | 0.7 | 231424 | 25.2 |
| IS 3 | 100% AA | 2.8 | 58490 | 25.9 |
| IS 4 | 100% AA | 5.6 | 19256 | 27.7 |
| IS 5 | 90% AA/10% EA | 2.1 | 61112 | 25.5 |
| IS 6 | 70% AA/30% EA | 2.1 | 54995 | 25.5 |
| CS 1 | 100% MAA | 1.0 | 15131 | 20.1 |
| CS 2 | 100% MAA | 1.0 | 16172 | 19.9 |
| CS 3 | 100% MAA | 0.2 | 28680 | 19.6 |

*AA = acrylic acid. EA = ethyl acrylate. MAA = methacrylic acid.

### Preparation and Testing of Soil Samples:

The stabilizer solutions in Table 2 are mixed with loose samples of soil in an amount such that the ratio of soil to stabilizer meets the ratio shown in Table 3. Two compacted soil samples are made from each mixed soil, using the methods described in ASTM D698-12: Standard Test Methods for Laboratory Compaction Characteristics of Soil Using Standard Effort.

Additional mixed soil samples and compacted samples are made using cement, commercial acidic polymers or commercial stabilizer, as shown in Table 3. IE1 to IE7 are inventive examples within the scope of the invention. CE1 to CE10 are comparative examples outside the scope of the invention.

Each compacted sample is tested for soil strength and soil expansion according to ASTM D1883: Standard Test Method for California Bearing Ratio (CBR) of Laboratory-Compacted Soils. Results are shown in Table 3.

TABLE 3

| | Stabilizer | CBR Strength | | CBR Expansion | |
|---|---|---|---|---|---|
| IE1 | 1% solids IS1b | 51.0 | 51.0 | 0.61 | 0.43 |
| IE2 | 1% solids IS2 | 44.5 | 42.8 | 0.44 | 0.26 |
| IE3 | 1% solids IS3 | 39.5 | 37.9 | 0.44 | 0.43 |
| IE4 | 1% solids IS4 | 26.3 | 26.3 | 0.44 | 0.44 |
| IE5 | 1% solids IS6 | 38.4 | 29.6 | 0.26 | 0.37 |
| IE6 | 1% solids IS7 | 36.2 | 31.3 | 0.26 | 0.43 |
| IE7 | 1% solids Commercial PAA Polymer 1 | 54.9 | 53.8 | 0.9 | 0.9 |
| CE1 | Control (no additive) | 13.2 | 18.7 | 0.79 | 0.70 |
| CE2 | 1% Cement by weight | 40 | — | 0.44 | — |
| CE3 | 2% Cement by weight | 56 | — | 0.43 | — |
| CE4 | 3% Cement by weight | 87 | 89 | 0.35 | 0.35 |
| CE5 | Enzyme treatment | 24 | 21 | 0.70 | 0.74 |
| | EarthZyme - 1 L for 33 m³ | | | | |
| CE6 | 1% solids ACRYSOL ™ ASE-60 | 17.6 | 18.7 | 0.44 | 0.35 |
| CE7 | 1% TAMOL ™ 731A dispersant | 9.9 | 8.8 | 0.26 | 0.17 |
| CE8 | 1% Solids CS1 | 16.5 | 13.2 | | |
| CE9 | 1% Solids CS3 | 18.1 | 15.4 | | |
| CE10 | 1% Solids CS2 | 13.2 | 14.8 | | |

1. A process to stabilize a layer of soil that contains high levels of clay, called “high-clay soil”, comprising the steps:
a. mixing together a loose layer of the high-clay soil with an aqueous stabilizer solution that contains (1) less than 0.05 parts organic amine per 100 parts high-clay soil; and (2) a dissolved polyacrylic acid polymer that:
i. has a weight average molecular weight (Mw) from 10,000 Da to 500,000 Da; and
ii. contains at least 60 weight percent repeating units derived from acrylic acid, based on the total weight of the polyacrylic acid polymer; and
b. compacting the loose high-clay soil layer.

2. The process of claim 1 wherein the high-clay soil meets AASHTO classification A-6 or A-7.

3. The process of claim 1 wherein from 70 to 100 weight percent of repeating units are derived from acrylic acid and from 0 to 30 weight percent of repeating units are derived from a comonomer.

4. The process of claim 1 wherein the quantity of polyacrylic acid in the aqueous stabilizer solution mixed with the loose layer of high-clay soil is from 0.1 to 4 weight percent of the loose layer of high-clay soil.

5. The process of claim 1 wherein the quantity of polyacrylic acid in the aqueous stabilizer solution mixed with the loose layer of high-clay soil is from 0.5 to 3 weight percent of the loose layer of high-clay soil.

6. The process of claim 1, wherein the aqueous stabilizer solution contains from 10 to 40 weight percent polyacrylic acid polymer.

7. The process of claim 1 wherein the aqueous stabilizer solution has a pH from 1.9 to 3.0.

8. The process of claim 1 wherein the aqueous stabilizer solution has a viscosity from 50 to 500 cP.

9. The process of claim 1 wherein the polyacrylic acid polymer has a weight average molecular weight (Mw) from 15,000 Da to 300,000 Da.

10. The process of claim 1 wherein
a. the aqueous stabilizer solution contains from 10 to 40 weight percent polyacrylic acid polymer and has a pH from 1.9 to 3.0;
b. the polyacrylic acid polymer is a homopolymer or a copolymer in which from 70 to 100 weight percent of repeating units are derived from acrylic acid and from 0 to 30 weight percent of repeating units are derived from methacrylic acid, methyl acrylate, ethyl acrylate, butyl acrylate, methyl methacrylate, ethylene, propylene or styrene; and
c. the quantity of polyacrylic acid in the aqueous stabilizer solution that is mixed with the loose layer of high-clay soil is from 0.5 to 3 weight percent of the loose layer of high-clay soil.

11. The process of claim 10 wherein the polyacrylic acid polymer is a homopolymer.

12. The process of claim 10 wherein the polyacrylic acid polymer is a copolymer in which from 70 to 99 weight percent of repeating units are derived from acrylic acid and from 1 to 30 weight percent of repeating units are derived from ethyl acrylate.

13. The process of claim 1 wherein the compaction in step (b) produces a compacted stabilized layer of high-clay soil that has a California Bearing Ratio of at least 30 percent, when measured according to the Test Methods.

14. The process of claim 13 wherein the compaction in step (b) produces a compacted stabilized layer of high-clay soil whose California Bearing Ratio is at least 2 times the California Bearing Ratio of similarly compacted high-clay soil without the polyacrylic acid polymer, when measured according to the Test Methods.
a. A compacted soil layer comprising:
b. at least 95 weight percent soil that contains high levels of clay, called “high-clay soil”; and
c. a water-soluble polyacrylic acid polymer in a concentration suitable to stabilize the high-clay soil, which polyacrylic acid polymer:
i. has a weight average molecular weight (Mw) from 10,000 Da to 500,000 Da; and
ii. contains at least 70 weight percent repeating units derived from acrylic acid; and
d. from 0 to less than 0.05 parts organic amine per 100 parts high-clay soil.
